(19) United States
(12) Patent Application Publication
(10) Pub. No.: US 2026/0044351 A1
(43) Pub. Date: Feb. 12, 2026

(54) System with a Communication Interface and a Restart Method Thereof

(71) Applicant: Artilux, Inc., Menlo Park, CA (US)

(72) Inventors: Kai-Chi Hsu, ZHUBEI CITY (TW); Chien-Lung Chen, ZHUBEI CITY (TW); Che-Fu Liang, ZHUBEI CITY (TW)

(21) Appl. No.: 19/287,757

(22) Filed: Jul. 31, 2025

Related U.S. Application Data
(60) Provisional application No. 63/681,871, filed on Aug. 11, 2024.

(51) Int. Cl. G06F 9/4401

(52) U.S. Cl. CPC G06F 9/4401

(57) ABSTRACT

An example method for a primary device to restart a secondary device through a communication interface. The secondary device includes a register table. The method includes performing, by the primary device and through the communication interface, a write transaction on the secondary device for a predetermined address in the register table. The method includes performing, by the primary device and through the communication interface, a read transaction on the secondary device for reading a predetermined register group in the register table to cause the secondary device to restart after completing the reading of the predetermined register group.

### RELATED APPLICATION

The present application claims the benefit of and priority to U.S. Provisional Patent Application No. 63/681,871, filed Aug. 11, 2024, which is hereby incorporated by reference in its entirety

### FIELD

The present disclosure relates to a system having a primary device and one or more secondary devices, and more particularly, to a method of performing the transaction over the communication interface to restart the secondary device.

### BACKGROUND

A device ecosystem can include a plurality of hardware devices. The hardware devices can communicate through a communication interface. Errors with respect to one device may impact other devices within the ecosystem.

### SUMMARY

The present disclosure relates to a system having a primary device and one or more secondary devices, and more particularly, to a method of performing the transaction over the communication interface to restart the secondary device. A system may have a primary device and a plurality of secondary devices connected to the primary device. The primary device and a secondary device can exchange data or control signals through a communication interface. When the secondary device is not working properly, the primary device or the system may assist to restart the secondary device to restore its original settings and status. The systems and methods described herein provide a technical solution to this technical problem by improving the capability to address errors on a running computing device via a restart, thereby improving the operation and extending the life of its hardware.

One example aspect of the present disclosure is directed to a method for a primary device to restart a secondary device through a communication interface. The secondary device includes a register table. The method includes performing, by the primary device and through the communication interface, a write transaction on the secondary device for a predetermined address in the register table. The method includes performing, by the primary device and through the communication interface, a read transaction on the secondary device for reading a predetermined register group in the register table to cause the secondary device to restart after completing the reading of the predetermined register group.

In some implementations, the secondary device includes a signal line configured to activate the restart of the secondary device.

In some implementations, the method includes triggering the signal line to restart the secondary device after completing the reading of the predetermined register group.

In some implementations, the signal line is a low-active signal line.

In some implementations, a number of data fields of the predetermined register group to be read in the read transaction is larger than or equal to a number of data fields read to cause the restart of the secondary device.

In some implementations, the predetermined register group includes a data field at the predetermined address.

In some implementations, the secondary device includes at least one shift register to detect the completion of reading of the predetermined register group.

In some implementations, the method includes resetting the at least one shift register when the read transaction is not for the predetermined register group.

In some implementations, the method includes resetting the at least one shift register after the write transaction.

In some implementations, the secondary device restarts when a plurality of shift registers are set to a specific level.

In some implementations, the communication interface is compatible with I2C protocol.

In some implementations, a data field of the predetermined address is read-only.

In some implementations, the method includes sequentially reading data fields of the predetermined register group from the predetermined address.

Another example aspect of the present disclosure is directed to a system. The system includes a primary device, a secondary device including a register table, and a communication interface configured to perform a read transaction and a write transaction between the primary device and the secondary device. The primary device is configured to: perform, through the communication interface, a write transaction on the secondary device for a predetermined address in the register table; and perform, through the communication interface, a read transaction on the secondary device for reading a predetermined register group in the register table. The secondary device is configured to restart after completing the reading of the predetermined register group.

In some implementations, the secondary device includes a signal line configured to be triggered to activate the restart of the secondary device.

In some implementations, the secondary device is configured to trigger the signal line to restart the secondary device after completing the reading of the predetermined register group.

In some implementations, the predetermined register group includes a data field at the predetermined address.

In some implementations, the secondary device includes at least one shift register, and the secondary device is configured to reset the at least one shift register after the write transaction.

In some implementations, the secondary device is configured to reset the at least one shift register when the read transaction signal is not for the predetermined register group.

Yet another example aspect of the present disclosure is directed to a method for a secondary device to restart by a primary device through a communication interface. The secondary device includes a register table. The method includes receiving, from the primary device and through the communication interface, a write transaction for a predetermined address in the register table. The method includes receiving, from the primary device and through the communication interface, a read transaction for reading a predetermined register group in the register table. The method includes, after completing the reading of the predetermined register group, restarting the secondary device.

### BRIEF DESCRIPTION OF THE DRAWINGS

The foregoing aspects and many of the advantages of this application will become more readily appreciated as the same becomes better understood by reference to the following detailed description, when taken in conjunction with the accompanying drawings:

FIG. 1 shows a system with an interface in accordance with an embodiment of the present disclosure.

FIG. 2 shows a register table in accordance with an embodiment of the present disclosure.

FIG. 3 shows the steps of restarting a secondary device by performing at least one transaction over the communication interface in accordance with an embodiment of the present disclosure.

FIGS. 4-5 show flows of restarting methods of a system in accordance with an embodiment of the present disclosure.

### DETAILED DESCRIPTION

The following embodiments accompany the drawings to illustrate the concept of the present disclosure. In the drawings or descriptions, similar or identical parts use the same reference numerals, and in the drawings, the shape, thickness, or height of the element can be reasonably expanded or reduced. The embodiments listed in the present application are only used to illustrate the present application and are not used to limit the scope of the present application. Any obvious modification or change made to the present application does not depart from the spirit and scope of the present application.

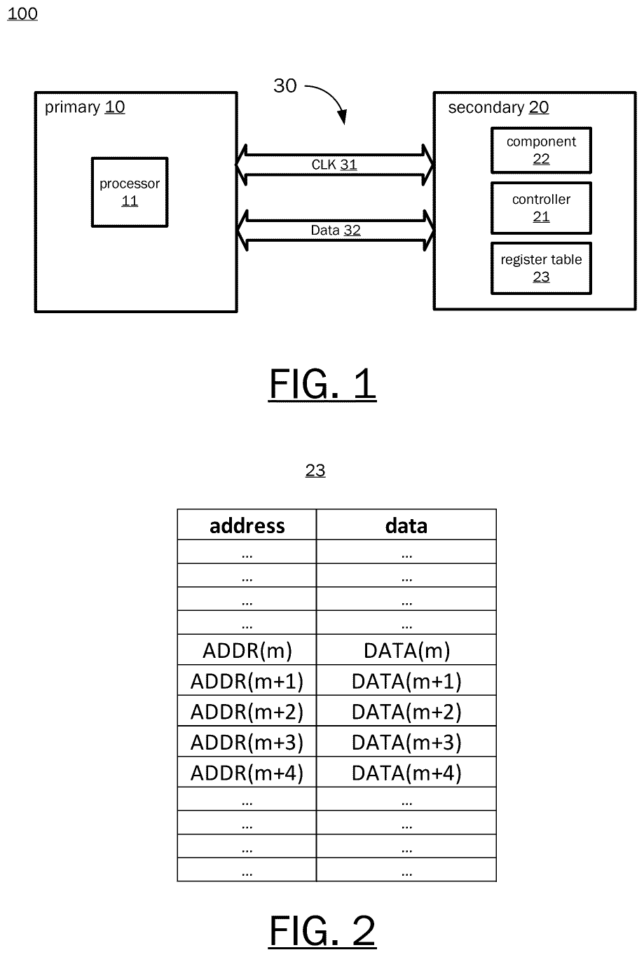

FIG. 1 shows a system 100 with a communication interface in accordance with an embodiment of the present disclosure. The system 100 includes a primary device 10 and a secondary device 20 coupling to the primary device 10 through a communication interface 30. The communication interface 30 can be compatible with communication protocols, such as I2C (inter-integrated circuit) protocol, or SPI (Serial Peripheral Interface) protocol. Take I2C interface as an example, the communication interface 30 at least includes a clock line 31 and a data line 32 to perform synchronized read transactions and write transactions between the primary device 10 and the secondary device 20. The clock line 31 is configured to transmit a clock signal from the primary device 10 to the secondary device 20. The data line 32 can be bidirectional in transmitting the data between the primary device 10 and the secondary device 20. The primary device 10 can be a computing device and includes a processor 11. The secondary device 20 can be a peripheral device, such as a headphone, speaker, game console, monitor, etc., and includes a controller 21, a component 22 that can be controlled by the controller 21, and a register table 23. The component 22 can be a light-emitting device, a speaker, a microphone, a monitor, etc. The primary device 10, the secondary device 20, and the communication interface 30 can all be implemented in a single apparatus. The primary device 10 can perform parameter setting or data exchange with the controller 21 of the secondary device 20 through the communication interface 30, and/or access the register table 23 of the secondary device 20 through the communication interface 30. The secondary device 20 can transmit data back to the primary device 10 through the communication interface 30 for data processing and analysis.

The secondary device 20 may at times malfunction or operate abnormally due to unexpected conditions, such as ambient temperature variation, unstable operating voltage, etc. In such cases, the secondary device 20 needs to be restarted to clear the configuration settings of the secondary device 20 to the default settings, clear memory space on the secondary device 20, remove personal information from the secondary device 20, or restart the operation process, etc. One method to do this is a hardware reset by implementing a hardware pin on the secondary device 20 to trigger a restart. A restart (and a reset process) can include closing running applications, clearing temporary data and caches from memory (e.g., RAM), reinitializing operating systems and hardware components, powering off the device (at least temporarily), powering on the device, and/or other operations. The primary device 10 or an external electrical signal (not shown) can connect to this hardware pin to restart the secondary device by generating a trigger signal, such as a high-to-low or low-to-high trigger signal. However, this approach requires designing a dedicated hardware pin for restart usage. Some small devices or systems may not have enough space to accommodate this circuit wiring.

Another method can be software reset. The primary device 10 can send a restart command including restart information to the secondary device 20 through the communication interface 30. The secondary device 20 will perform the restart process after receiving the restart command. However, this method requires that the memory of the secondary device 20 can accept the data writing operation from the primary device 10 during operation. After confirming that the written data is a restart command containing restart information, the restart process will be executed. In certain operating conditions, the memory of the secondary device 20 cannot be written to. For example, the secondary device 20 includes a light-emitting device. If the secondary device 20 is not permitted to emit light, and the primary device 10 performs a write transaction on the secondary device 20 through the communication interface 30, the operating parameters of the secondary device 20 may be set incorrectly. This could cause the secondary device 20 to emit light by mistake, leading to light leakage and harming human eyes. In order to avoid light leakage, when the secondary device 20 is not allowed to emit light, it may not accept writing operations from the primary device 10. The present disclosure describes a method and system to perform a software reset on a secondary device 20 without writing a restart command.

FIG. 2 shows a register table 23 in accordance with an embodiment of the present disclosure. The register table 23 of the secondary device 20 can be stored in an EEPROM such as a flash memory to store configuration settings related to the secondary device 20. In another embodiment, the register table 23 can be implemented by at least one logic circuit integrated in the controller 21. The register table 23 contains a plurality of address fields ADDR and a plurality of data fields DATA. Each address field ADDR corresponds to one data field DATA. The address field ADDR and the data field DATA can contain several bits (e.g., 1 byte, 2 byte) of information. Each data field can be independently configured as read-only or writable.

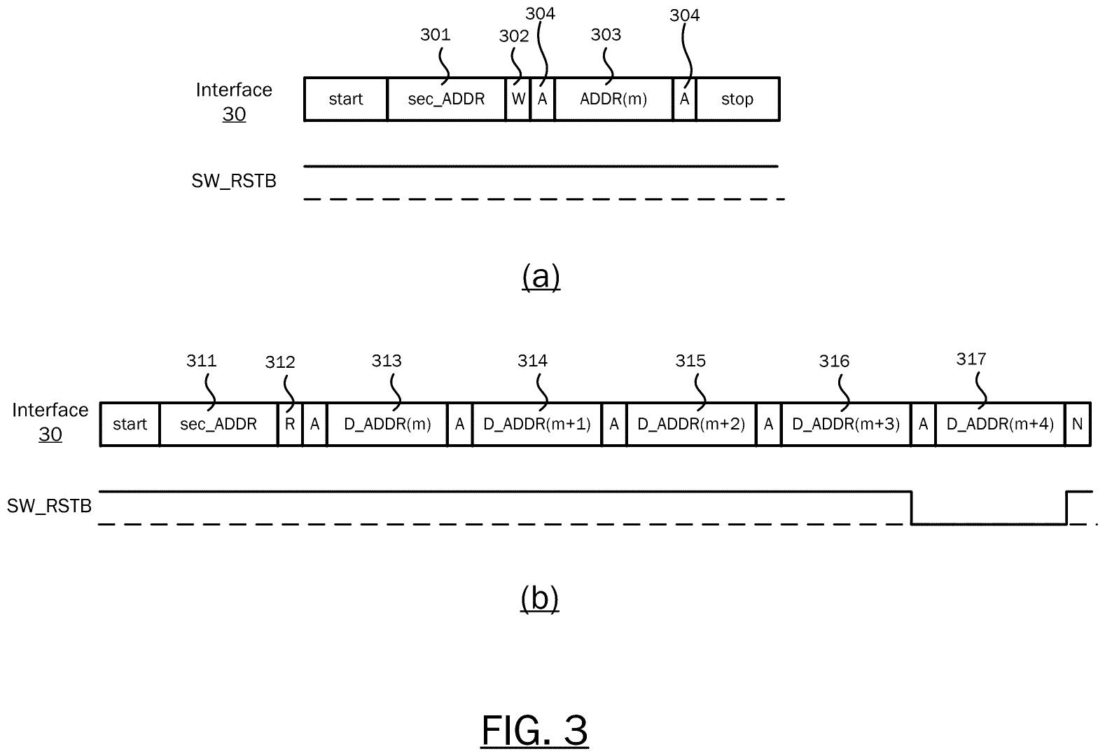

FIG. 3 shows the steps of restarting a secondary device by performing at least one transaction over the communication interface in accordance with an embodiment of the present disclosure. The secondary device 20 may have a signal line that carries a restart signal SW_RSTB and is configured to activate the restart of the secondary device 20. The signal line carrying the restart signal SW_RSTB can be a low-active signal line and generally remains high. In step (a), when the primary device 10 starts to perform the restart procedure on the secondary device 20, the primary device 10 performs a write transaction to the data field of a predetermined address ADDR(m) in the register table 23 of the secondary device 20 through the communication interface 30. For example, the secondary device 20 has a specific address sec_ADDR used to indicate its identification and communicate with the primary device 10. The write transaction signal on the I2C interface 30 includes a first field 301, which contains the specific address (sec_ADDR) for the secondary device. Following the first field 301, a second field 302 contains a write request (W), indicating a writing operation. Following the second field 302, a third field 303 contains a predetermined address (ADDR(m)), which corresponds to a predetermined data field intended to be written. In some embodiments, the predetermined data field corresponding to the predetermined address ADDR(m) can be read-only, or the register table 23 does not accept written data during operation. Therefore, the write transaction signal may not contain data information following the third field 303, which includes the predetermined address (ADDR(m)).

In step (b), after the primary device 10 transmits the write transaction signal for the predetermined address ADDR(m), the primary device 10 transmits a read transaction signal to the secondary device 20 through the communication interface 30 to trigger the restart control signal SW_RSTB to restart the secondary device 20. In some embodiments, the primary device 10 continuously reads a predetermined register group through the read transaction signal. The predetermined register group includes a plurality of data fields at a plurality of corresponding addresses in the register table 23. The data field at the predetermined address ADDR(m) is one of the plurality of data fields of the predetermined register group and can be the first data of the predetermined register group. After completing a continuous reading of the predetermined register group, the restart control signal SW_RSTB of the secondary device 20 is triggered to activate the secondary device restart. For example, the read transaction signal on the I2C interface includes a first field 311, which contains the specific address (sec_ADDR) for the secondary device. Following the first field 311, a second field 312 contains a read request 305 (R), indicating a reading operation. Following the second field 312, a plurality of reading fields 313-317 contain data read from a plurality of data fields in the predetermined register group. Here, the first reading field 313 contains the data D_ADDR(m) of data field at the predetermined address ADDR(m). The second reading field 314 to the fifth reading field 317 sequentially include the data D_ADDR(m+1) to D_ADDR(m+4) of data fields at the address ADDR(m+1) to the address ADDR(m+4). When the number of data fields read reaches 4, the restart control signal SW_RSTB of the secondary device 20 changes from a high level to a low level, and the secondary device 20 restarts. In other words, when the data field at the fourth address ADDR(m+3) is read, the restart control signal SW_RSTB changes to the low level, and the secondary device 20 restarts. The number of data fields of the predetermined register group to be read in the read transaction signal can be larger than or equal to the number of data fields read continuously that can trigger the restart control signal SW_RSTB. In step (b), the number of data fields of the predetermined register group to be read in the read transaction signal is 5, and the number of data fields read continuously that can trigger the restart control signal SW_RSTB is 4. However, in another embodiment, the number of data fields of the predetermined register group to be read in the read transaction signal can be any suitable number (e.g., 3, 4, 5, 6, etc.).

In an embodiment, the secondary device 20 can use at least one shift register to detect the completion of continuous read of the predetermined register group of the secondary device 20 to trigger the restart control signal SW_RSTB. For the predetermined register group, after reading one register, a corresponding shift register is set to a specific level (e.g., 1). The number of shift registers can be equal to the number of data fields read continuously that can trigger the restart control signal SW_RSTB. Taking FIG. 3 as an example, the secondary device 20 can include 4 shift registers to detect the completion of continuous read of the predetermined register group. Once all shift registers are at this specific level, the restart control signal SW_RSTB is triggered to be low level, and the secondary device 20 restarted. When the secondary device 20 receives the write transaction signal for the predetermined address ADDR(m), all shift registers can be reset, for example, set to 0. In another embodiment, when the secondary device 20 receives the read transaction signal and the address information is not the predetermined register group, all shift registers can be reset, for example, set to 0.

In another embodiment, the primary device 10 can read the predetermined register group of the secondary device 20 in a non-continuous manner. For example, multiple read transaction signals may be utilized to complete the reading of the predetermined register group through interval or periodic readings, in order to trigger the restart control signal SW_RSTB.

In another embodiment, in the read transaction signal, the predetermined register group to be read includes the data field D_ADDR(m) at the predetermined address ADDR(m), and the addresses of other data fields in the predetermined register group to be read are not continuous.

In one embodiment, when the secondary device 20 receives 1 byte (e.g., the first field 301 of the write transaction signal contains the specific address (sec_ADDR) plus the second field 302 containing a write request (W), the third field 303 of the write transaction signal contains the predetermined address (ADDR(m)), or the reading fields 313-317 of the read transaction signal contains data in the data field of the predetermined register group) from the communication interface 30, the secondary device 20 may return one ACK bit (A) 304 to the primary device 10.

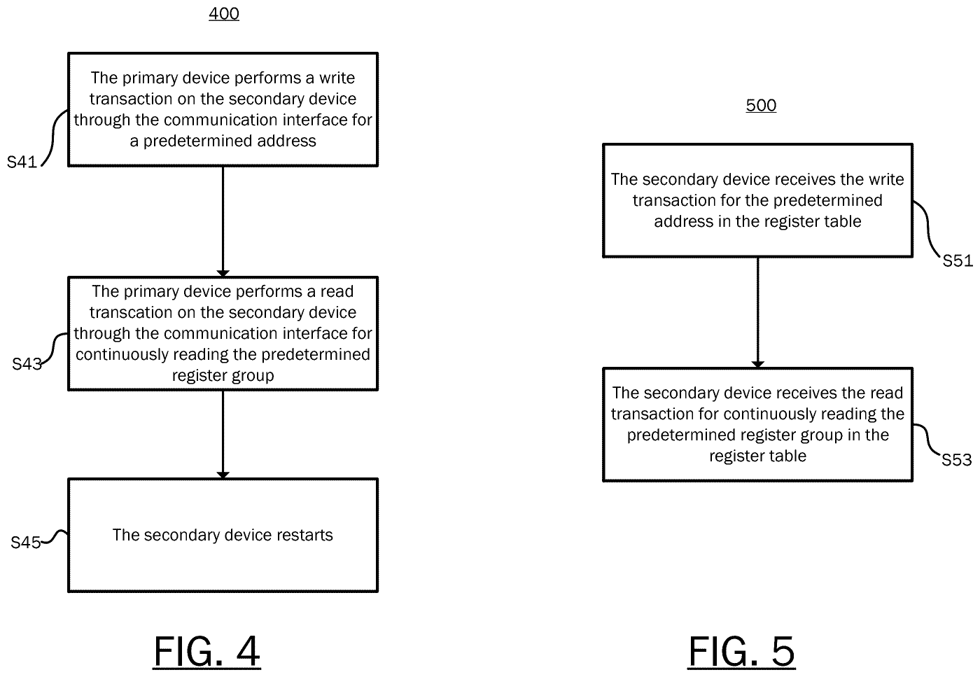

FIGS. 4-5 show flows of restarting methods 400 and 500 of a system in accordance with an embodiment of the present disclosure.

At S41, the primary device performs a write transaction on the secondary device through the communication interface for a predetermined address. The predetermined address can be in the register table. The data field of the predetermined address can be read-only. The communication interface can be compatible with I2C protocol.

At S51, the secondary device can receive the write transaction signal for the predetermined address (e.g., in the register table).

At S43, the primary device performs a read transaction on the secondary device, through the communication interface, for continuously reading of the predetermined register group (e.g., in the register table) to cause the secondary device to restart after completing the continuous reading of the predetermined register group.

For example, at S53, the secondary device can receive, from the primary device and through the communication interface, a read transaction for continuously reading a predetermined register group in the register table.

At S45, the secondary device can restart. For example, after completing a continuous reading of the predetermined register group, the secondary device can reset. In some implementations, a plurality of shift registers are set to a specific level (e.g., 1) and the restart control signal of the secondary device is triggered to activate the secondary device restart. In some implementations, the plurality of shift registers may include all the shift registers associated with the secondary device. The secondary device may restart, for example, when a plurality of shift registers are set to a specific level (e.g., 1).

In some embodiments, the reading method described in the aforementioned steps is non-continuous, which means that the secondary device restarts after completing the reading of the predetermined register group. For example, the predetermined register group is read through interval reading and periodic reading by executing multiple reading transactions.

In some implementations, the secondary device can include a signal line (e.g., a low-active signal line) configured to activate the restart of the secondary device. The methods 400/500 can include triggering the signal line to restart the secondary device after completing the continuous reading of the predetermined register group. The predetermined register group can include, for example, a data field at the predetermined address. In an example, a number of data fields of the predetermined register group to be read in the read transaction is larger than or equal to a number of data fields read continuously to cause the restart of the secondary device.

In some implementations, the secondary device may include at least one shift register to detect the completion of continuous read of the predetermined register group. Reset of the secondary device may include resetting the at least one shift register when the read transaction is not for the predetermined register group. This can include, for example, resetting the at least one shift register after the write transaction.

While the disclosure has been described by way of example and in terms of a preferred embodiment, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for a primary device to restart a secondary device through a communication interface, the secondary device comprising a register table, the method comprising:
performing, by the primary device and through the communication interface, a write transaction on the secondary device for a predetermined address in the register table; and
performing, by the primary device and through the communication interface, a read transaction on the secondary device for reading a predetermined register group in the register table to cause the secondary device to restart after completing the reading of the predetermined register group.

2. The method of claim 1, wherein the secondary device comprises a signal line configured to activate the restart of the secondary device.

3. The method of claim 2, further comprising triggering the signal line to restart the secondary device after completing the reading of the predetermined register group.

4. The method of claim 2, wherein the signal line is a low-active signal line.

5. The method of claim 1, wherein a number of data fields of the predetermined register group to be read in the read transaction is larger than or equal to a number of data fields read to cause the restart of the secondary device.

6. The method of claim 1, wherein the predetermined register group includes a data field at the predetermined address.

7. The method of claim 1, wherein the secondary device comprises at least one shift register to detect the completion of reading of the predetermined register group.

8. The method of claim 7, further comprising resetting the at least one shift register when the read transaction is not for the predetermined register group.

9. The method of claim 7, further comprising resetting the at least one shift register after the write transaction.

10. The method of claim 7, wherein the secondary device restarts when a plurality of shift registers are set to a specific level.

11. The method of claim 1, wherein the communication interface is compatible with I2C protocol.

12. The method of claim 1, wherein a data field of the predetermined address is read-only.

13. The method of claim 1, further comprising sequentially reading data fields of the predetermined register group from the predetermined address.

14. A system comprising:
a primary device;
a secondary device comprising a register table;
a communication interface configured to perform a read transaction and a write transaction between the primary device and the secondary device;
wherein the primary device is configured to:
perform, through the communication interface, a write transaction on the secondary device for a predetermined address in the register table; and
perform, through the communication interface, a read transaction on the secondary device for reading a predetermined register group in the register table, and
wherein the secondary device is configured to restart after completing the reading of the predetermined register group.

15. The system of claim 14, wherein the secondary device comprises a signal line configured to be triggered to activate the restart of the secondary device.

16. The system of claim 15, wherein the secondary device is configured to trigger the signal line to restart the secondary device after completing the reading of the predetermined register group.

17. The system of claim 14, wherein the predetermined register group includes a data field at the predetermined address.

18. The system of claim 14, wherein the secondary device comprises at least one shift register, and wherein the secondary device is configured to reset the at least one shift register after the write transaction.

19. The system of claim 18, wherein the secondary device is configured to reset the at least one shift register when the read transaction signal is not for the predetermined register group.

20. A method for a secondary device to restart by a primary device through a communication interface, the secondary device comprising a register table, the method comprising:
receiving, from the primary device and through the communication interface, a write transaction for a predetermined address in the register table;
receiving, from the primary device and through the communication interface, a read transaction for reading a predetermined register group in the register table; and
after completing the reading of the predetermined register group, restarting the secondary device.
